(19) United States
(12) Patent Application Publication
(10) Pub. No.: US 2013/0168540 A1
(43) Pub. Date: Jul. 4, 2013

(54) LIGHT GRATING STRUCTURE FOR A FORCE FEEDBACK DEVICE

(71) Applicant: QUANTA STORAGE INC., Taoyuan County (TW)

(72) Inventors: Chien-Hui Hsu, Taoyuan County (TW); Yu-Ming Chang, Taoyuan County (TW); Jen-Chen Wu, Taoyuan County (TW)

(73) Assignee: QUANTA STORAGE INC., Taoyuan County (TW)

(21) Appl. No.: 13/645,496

(22) Filed: Oct. 4, 2012

(30) Foreign Application Priority Data
Dec. 30, 2011 (CN) 201110453943.6

(51) Int. Cl. G01D 5/34

(52) U.S. Cl. 250/237 G

(57) ABSTRACT

The invention is to provide a light grating structure for a force feedback device, projecting a light beam from a light source through the pervious parts of a grating body to form pervious areas at a reception end, blocking the light beam by the shade parts of the grating body to form shade areas at the reception end, and increasing the grating distance to move the grating body close to the reception end and increasing the width of the shade part bigger than the pervious part to enable the width of the shade area to equal to the width of the pervious area.

### BACKGROUND OF THE INVENTION

1. Field of the Invention

The present invention relates to a light grating structure, and more specifically, to a light grating structure for detecting a shift of a stick operated to perform multiple axis control in interfaces of games or vehicles.

2. Description of the Prior Art

A force feedback device mainly utilizes a stick to perform multiple axial shifts. It is needed to detect the shifts of the stick accurately to locate a subject in a desired position correctly.

Please refer to FIG. 1 and FIG. 2. FIG. 1 is a diagram of a light grating structure 10 of the force feedback device in the prior art. FIG. 2 is a diagram of a shift signal of the light grating structure 10 in the prior art. The light grating structure 10 includes a grating body 11 which is driven by a stick (not shown in figures). Pervious parts 12 and shade parts 13 are separately arranged at intervals on the grating body 11. A source end 14 and a reception end 15 are respectively disposed at two different sides of the grating body 11. A light source 16 disposed at the source end 14 corresponds to alight sensor 17 at the reception end 15. The light source 16 emits a light beam onto the grating body 11, and the light beam passes through the pervious parts 12 to be received by the light sensor 17, so as to generate an ON signal. On the contrary, if the light source 16 emits the light beam onto the shade parts 13 of the grating body 11, the shade parts 13 will block the light beam. As a result, the light sensor 17 is not able to receive the light beam, and therefore the light sensor 17 generates an OFF signal. As shown in FIG. 2, the shift signal of the stick is generated according to the ON signals and the OFF signals by the grating body 11 blocking the light sensor 17 in sequence.

In addition, a pervious width a of the pervious part 12 is equal to a shade width b of the shade part 13. The light beam emitted from the light source 16 passes through the pervious part 12 of the grating body 11 to form a spread angle θ. The light beam emitted onto the reception end 15 forms an enlarged pervious area 18. Besides, another light source 16′ emits another light beam onto the reception end 15 to form another pervious area. Therefore, a shade area 19 is shrunk by the two lateral pervious areas. As shown in FIG. 2, a width B of the shade area 19 is apparently less than a width A of the pervious area 18. As a result, duration of the light sensor 17 corresponding to the pervious area 18 is longer than duration of the light sensor 17 corresponding to the shade area 19. That is, duration of the ON signal is longer than duration of the OFF signal. A difference of the ON signal and the OFF signal will cause errors of detecting the shift of the stick, so that the subject cannot be located correctly. Therefore, there are problems to be solved in the light grating structure for the force feedback device.

### SUMMARY OF THE INVENTION

The present invention is to provide a light grating structure for a force feedback device to reduce the errors of detecting a shift of a stick by increasing a distance between a grating body and a source end and setting widths of a pervious part and a shade part.

A purpose of the present invention is to provide a light grating structure capable of eliminating inaccuracy of detecting a shift signal of the stick and increasing accuracy of controlling the stick by disposing the grating body away from the source end with a grating distance and setting widths of a pervious part and a shade part, to remain the condition that widths of a pervious area and a shade area are the same.

According to the disclosure, a light grating structure for a force feedback device includes a grating body and a sensor unit. The force feedback device utilizes a stick to drive an axial stick, and the axial stick is driven to move in at least one direction, so as to rotate the light grating structure through a gear set. Pervious parts and shade parts are separately arranged at intervals on the grating body, each pervious part has a pervious width, and each shade part has a shade width. The sensor unit includes a light source and a light sensor. The light source is at a source end for emitting a light beam, and the source end is apart from the grating body by a grating distance. The light sensor is at a reception end for receiving the light beam, and the source end and the reception end are disposed at two different sides of the grating body with a sensing distance.

According to the disclosure, the light sensor receives the light beam emitted from the light source onto the pervious areas and transforms the light beam into an ON signal, and the light sensor generates an OFF signal as the light sensor receives no light beam on shade areas. By increasing the grating distance, the grating body is close to the reception end, and by increasing the width of the shade part bigger than the pervious part, the width of the shade area is equal to the width of the pervious area.

According to the disclosure, alight source width, the sensing distance, the grating distance, the pervious width and the shade width have a relation derived as follows:

the shade width=(the pervious width)*[(2*the sensing distance/the grating distance)−1]−2*the light source width[(the sensing distance/the grating distance)−1].

According to the disclosure, the pervious width is as twice as the light source width of the light source.

According to the disclosure, the grating distance is equal to four fifths of the sensing distance, so that the grating body is close to the reception end to keep safe distance.

According to the disclosure, a ratio of the shade width and the pervious width is five fourths.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a light grating structure of a force feedback device in the prior art.

FIG. 2 is a diagram of a shift signal of the light grating structure in the prior art.

FIG. 3 is a schematic drawing of a force feedback device according to the present invention.

FIG. 4 is a schematic drawing of a light grating structure for the force feedback device according to the present invention.

FIG. 5 is a sectional view of the light grating structure according to the present invention.

FIG. 6 and FIG. 7 respectively illustrate a grating body arranged in different positions according to the present invention.

FIG. 8 is a diagram of a shift signal of the light grating structure according to the present invention.

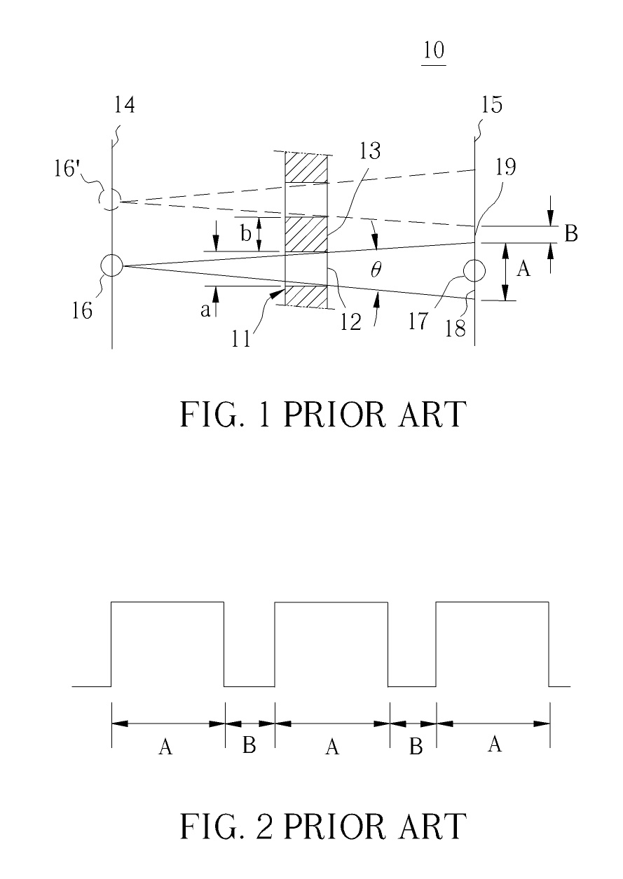

### DETAILED DESCRIPTION

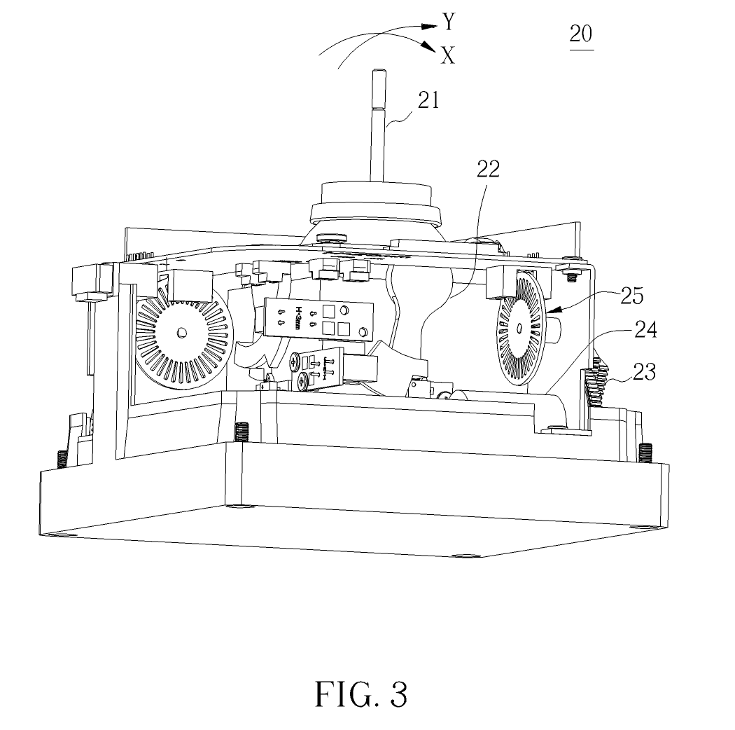

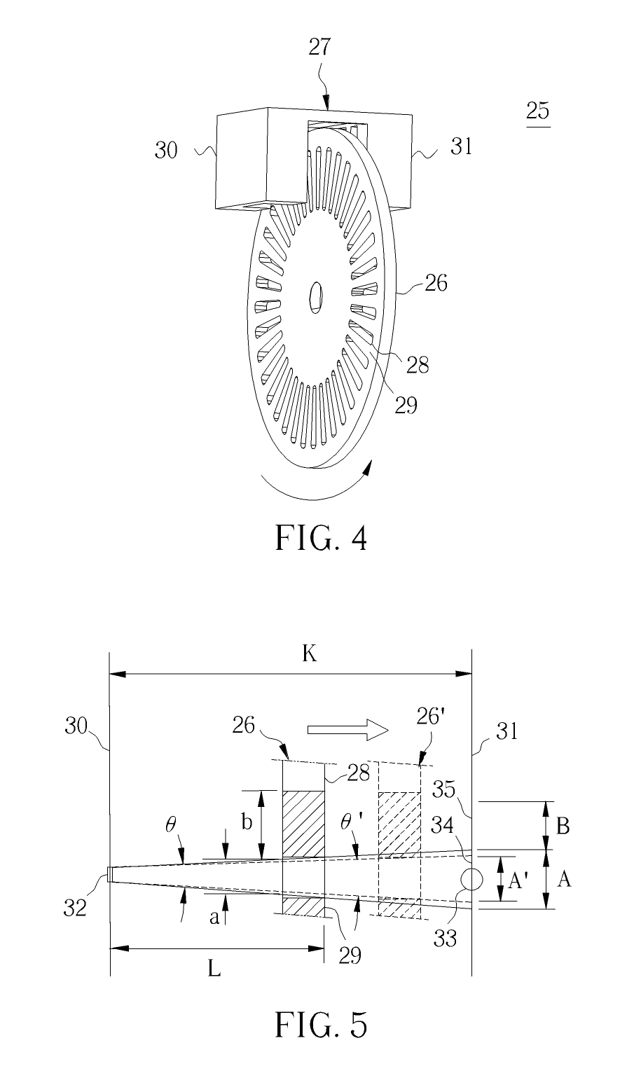

Please refer to FIG. 3, FIG. 4 and FIG. 5. FIG. 3 is a schematic drawing of a force feedback device 20 according to the present invention. FIG. 4 is a schematic drawing of a light grating structure 25 for the force feedback device 20 according to the present invention. FIG. 5 is a sectional view of the light grating structure 25 according to the present invention. The force feedback device 20 utilizes a stick 21 to drive an axial stick 22, and the axial stick 22 is driven to move in at least one direction, such as in X axis or Y axis. The axial stick 22 is connected to a motor 24 and the light grating structure 25 via a gear set 23. The light grating structure 25 includes a grating body 26 and a sensor unit 27. Pervious parts 28 and shade parts 29 are separately arranged at intervals on the grating body 26. Each pervious part 28 has a pervious width a for a light beam passing through. The shade parts 29 have a shade width b for blocking the light beam from passing through. An end of the sensor unit 27 is a source end 30, and the other end of the sensor unit 27 is a reception end 31. The source end 30 is apart from the reception end 31 by a sensing distance K, and the source end 30 and the reception end 31 are respectively disposed at two different sides of the grating body 26. The source end 30 is apart from the grating body 26 by a grating distance L. Alight source 32 disposed at the source end 30 corresponds to a light sensor 33 disposed at the reception end 31. A light beam emitted from the light source 32 can be received by the light sensor 33.

As the stick 21 drives the grating body 26 to rotate, the light source 32 emits the light beam onto the grating body 26, and then the light beam passes through the pervious parts 28 to the reception end 31 to form pervious areas 34. And then the light beam is received by the light sensor 33 and is transformed into an ON signal. On the contrary, as the light beams is emitted onto the shade parts 29, the shade parts 29 blocks the light beam to form shade areas 35. As a result, the light sensor 33 receives no light beam and generates an OFF signal accordingly. A shift signal of the stick 21 is formed according to the ON, OFF signals in sequence. Next, the motor 24 generates corresponding power feedback to the stick 21.

Please refer to FIG. 5. In order to enlarge the shade areas 35, first of all, it is desired to increase the grating distance L between the grating body 26 and the source end 30 as keeping the same pervious width a. That is, the grating body 26 is moved away from the source end 30 to a position where a grating body 26′ represents in dash lines. Therefore, a spread angle θ formed by the light beam emitted from the light source 32 will reduce to a spread angle θ′ accordingly. As a result, a width A of each pervious area 34 on the reception end 31 will reduce to a width A′ accordingly. If it only moves the grating body 26 to the reception end 31, the grating body 26 is needed to close the reception end 31 extremely for decreasing the width A of each pervious area 34 and increasing a width B of each shade area 35. But when the grating body 26 closes to the reception end 31 and rotates, it is possible that the grating body 26 damages the light sensor 33. Therefore, it preferably increases the shade width b of the shade part 29, so as to increase the width B of the shade area 35. By increasing the grating distance L and setting that the shade width b is larger than the pervious width a, the width B of the shade area 35 will be equal to the width A of the pervious area 34 substantially.

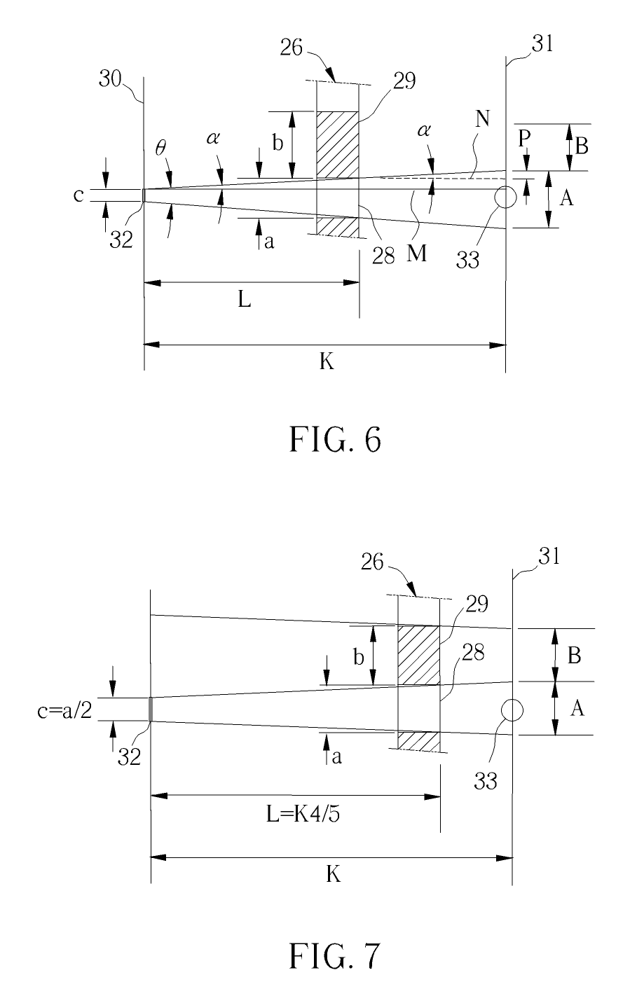

Please refer to FIG. 6 and FIG. 7. FIG. 6 and FIG. 7 respectively illustrate the grating body 26 arranged in different positions according to the present invention. Although the light source 32 is so small and can be regarded as a light point, it cannot be neglected relative to the pervious width a of the pervious part 28. Hence, a light source width c of the light source 32 is taken into consideration. There is an included angle α formed between an extension line M extending from an edge of the light source 32 and an edge of the spread angle θ. There is an erosion zone P formed between an extension line N extending from an edge of the shade part 29 and the edge of the spread angle θ. And because the extension line N is parallel to the extension line M, the included angle α is also formed between the extension line N and the edge of the spread angle θ. According to above conditions, it can be derived:

P/(K−L)=[(a−c)/2]/L (1)

The equation, P=(b−B)/2, is substituted into the formula (1), so it can be derived:

b−B=(a−c)[(K/L)−1] (2)

The relation of the width A and the width a is: [(A−c)/2]/[(a−c)/2]=K/L, after rearrangement, it can be derived:

A=[K(a−c)/L]+c (3)

It is desired the width A of the pervious area 34 is equal to the width B of the shade area 35, that is B=A, then substitute B=A into the formula (3), and it can be derived:

B=[K(a−c)/L]+c (4)

and substitute formula (4) into the formula (2), hence it can be derived following relation:

b=a[(2K/L)−1]−2c[(K/L)−1] (5)

Because the sensing distance K between the source end 30 and the reception end 31 of the sensor unit 27 and the light source width c are generally constant, the formula (5) shows the relation of the pervious width a of the pervious part 28, the shade width b of the shade part 29 and the grating distance L, to meet the condition that the width A of the pervious area 34 is equal to the width B of the shade area 35.

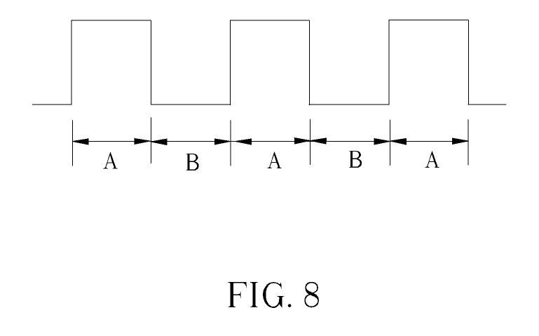

Please refer to FIG. 8. FIG. 8 is a diagram of a shift signal of the light grating structure 25 according to the present invention. In order to implement the formula (5), for example, the grating body 26 is moved to a position where the grating distance L is equal to four fifths of the sensing distance K, so that the grating body 26 can be close to the reception end 31 and keep safe distance. In addition, in order to prevent the pervious width a of the pervious part 28 from being decreased excessively, resulting in no sufficient light beam passing through the pervious part 28 to affect the detection of the light sensor 33, the pervious width a of the pervious part 28 can be set as twice as the light source width c of the light source 32, that is c=a/2. Substitute above relation into the formula (5), it can be derived that b/a=5/4. If the light source width c of the light source 32 is determined, the pervious width a of the pervious part 28 is derived from the relation a=2c, and the shade width b of the shade part 29 is derived that b=(5/2)c. As a result, the width A of the pervious area 34 is equal to the width B of the shade area 35. As shown in FIG. 8, it can ensure that the duration of the ON signal and the OFF signal of the light sensor 33 are the same.

Therefore, the light grating structure of the present invention achieve the purpose of eliminate inaccuracy of detecting the shift signal of the stick and increasing accuracy of controlling the stick by disposing the grating body away from the source end with a grating distance, disposing the grating body close to the reception end, setting the widths of the pervious part and the shade part with above-mentioned formulae to remain the condition that the widths of the pervious area and the shade area are the same.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light grating structure for a force feedback device, comprising:
a grating body whereon pervious parts and shade parts are separately arranged at intervals, each pervious part having a pervious width, and each shade part having a shade width; and
a sensor unit comprising:
a light source at a source end for emitting a light beam, the source end being apart from the grating body by a grating distance; and
a light sensor at a reception end for receiving the light beam, the source end and the reception end being disposed at two different sides of the grating body with a sensing distance;
wherein the light source emits the light beam onto the grating body and the light beam passes through the pervious parts to the reception end to form pervious areas, the shade parts block the light beam to form shade areas at the reception end, the grating distance is lager than a distance between the grating body and the reception end, and the shade width is larger than the pervious width, so that a width of each shade area is equal to a width of each pervious area.

2. The light grating structure of claim 1, wherein the light sensor receives the light beam emitted from the light source onto the pervious areas and transforms the light beam into an ON signal, and the light sensor generates an OFF signal as the light sensor receives no light beam on shade areas, so that the ON signal and the OFF signal have the same duration.

3. The light grating structure of claim 1, wherein a light source width, the sensing distance, the grating distance, the pervious width and the shade width have a relation derived as follows:
the shade width=(the pervious width)*[(2*the sensing distance/the grating distance)−1]−2*the light source width[(the sensing distance/the grating distance)−1].

4. The light grating structure of claim 3, wherein the pervious width is as twice as the light source width of the light source.

5. The light grating structure of claim 4, wherein the grating distance is equal to four fifths of the sensing distance, so that the grating body is close to the reception end to keep safe distance.

6. The light grating structure of claim 4, wherein the grating distance is equal to four fifths of the sensing distance, and a ratio of the shade width and the pervious width is five fourths.
